(19) United States
(12) Patent Application Publication
(10) Pub. No.: US 2026/0309418 A1
(43) Pub. Date: Oct. 8, 2026

(54) PARALLEL-FLOW REGENERATIVE SHAFT KILN AND METHOD FOR BURNING CARBONATE ROCK

(71) Applicants: Maerz Ofenbau AG, Zurich (CH); thyssenkrupp AG, Essen (DE)

(72) Inventors: Hannes PIRINGER, Beinwil am See (CH); Patrick BUCHER, Schoenenwerd (CH)

(73) Assignees: Maerz Ofenbau AG, Zurich (CH); thyssenkrupp AG, Essen (DE)

(21) Appl. No.: 19/481,824

(22) PCT Filed: May 6, 2024
(86) PCT No.: PCT/EP2024/062456

§ 371 Date: Nov. 5, 2025

(30) Foreign Application Priority Data
May 10, 2023 (BE) BE 2023/5381
May 10, 2023 (DE) 10 2023 112 291.6

(51) Int. Cl. F27B 1/02; F27B 1/00; F27B 1/24; F27D 9/00

(52) U.S. Cl. CPC F27B 1/02; F27B 1/005; F27B 1/24; F27D 9/00; F27D 2009/007

(57) ABSTRACT

A parallel-flow regenerative shaft kiln for burning and cooling material, such as carbonate rock, comprises two shafts which are operable alternately as a burning shaft and as a regenerative shaft and are connected to one another by a connecting duct, wherein in the flow direction of the material each shaft comprises a preheating zone for preheating the material, a burning zone for burning the material and a cooling zone for cooling the material, wherein each shaft has an offgas outlet for discharging offgas from the shaft, wherein the PFR shaft kiln has a cooling gas outlet for discharging cooling gas from the shaft and wherein the cooling gas outlet is arranged in the preheating zone or the burning zone. In a method of burning material, such as carbonate rocks, in a parallel-flow regenerative shaft kiln having two shafts, which are operated alternately as a burning shaft and as a regenerative shaft and are connected to one another by a connecting duct, the material flows through a material inlet into a preheating zone for preheating the material, a burning zone for burning the material and a cooling zone for cooling the material to a material outlet, wherein a cooling gas is admitted into the cooling zone, wherein offgas is discharged from one of the shafts via an offgas outlet and wherein the cooling gas is discharged from at least one of the shafts via a cooling gas outlet in the preheating zone or the burning zone.

The invention relates to a parallel-flow regenerative shaft kiln (PFR shaft kiln), and to a method of burning and cooling material, such as carbonate rock, with a PFR shaft kiln.

Burning of carbonate rock in a PFR shaft kiln has been known for about 60 years. A PFR shaft kiln of this kind, which is known for example from DE 10 2021 204 176A 1, has two vertical, parallel shafts in cyclical operation, with burning only in one shaft, the respective burning shaft, while the other shaft works as a regenerative shaft. The burning shaft is supplied with oxidant gas in concurrent with the material and fuel, and the resultant hot offgases, together with the heated cooling air which is supplied from below, are conducted via the crossover duct into the regenerative shaft, where the offgases are conducted away upward in countercurrent to the material and at the same time preheat the material. The material is typically supplied to the shaft from above together with the oxidant gas, with injection of fuels in the burning zone.

In each shaft, the material to be burned typically passes through a preheating zone for preheating of the material, a downstream burning zone in which the material is burned, and a downstream cooling zone in which cooling air is supplied to the hot material.

In order to meet the quality demands with respect to high reactivity of the burnt lime, as required for example in steelworks, the temperatures in the burning zone must not exceed a value of 1100 ° C., preferably 1000 ° C. Furthermore, demand for environmentally friendly production of burnt lime is also increasing, and so certain requirements for the CO₂ content of the offgas for subsequent aftertreatment must be met. However, the production of environmentally friendly lime should be as cost-effective as possible and only require minimal revamping measures for existing plants. Furthermore, the operation of the lime kilns should be as energy-efficient as possible.

Proceeding therefrom, the object of the present invention is to provide a PFR shaft kiln and a method of burning carbonate rock with a PFR shaft kiln which make it possible to produce lime having a high reactivity with simultaneous CO₂ separation from the offgas, wherein lime production is carried out in an energy efficient and cost-effective manner.

This object is achieved according to the invention by an apparatus having the features of independent apparatus claim 1 and by a process having the features of independent process claim 11. Advantageous refinements will become apparent from the dependent claims.

In a first aspect the invention comprises a parallel-flow regenerative shaft kiln for burning and cooling material, such as carbonate rock, having two shafts which are operable alternately as the burning shaft and as the regenerative shaft and are connected to one another by means of a connecting duct, wherein in the flow direction of the material each shaft comprises a preheating zone for preheating the material, a burning zone for burning the material and a cooling zone for cooling the material, wherein each shaft has an offgas outlet for discharging offgas from the shaft. The PFR shaft kiln has a cooling gas outlet for discharging cooling gas from the shaft, wherein the cooling gas outlet is arranged in the preheating zone or the burning zone. The cooling gas outlet in particular is entirely and exclusively arranged in the preheating zone or the burning zone.

The material to be burned is preferably limestone or dolomite rock having a particle size of 10 mm to 200 mm, preferably of 15 to 120 mm, most preferably 30 mm to 100 mm. The cooling gas is air, for example.

The parallel-flow regenerative shaft kiln has at least two shafts which are preferably arranged parallel to one another and vertically. The shafts are operable alternately as the burning shaft and as the regenerative shaft, wherein in the flow direction of the material each shaft has a preheating zone for preheating the material, a burning zone for burning the material and a cooling zone for cooling the material. Each shaft preferably has a material inlet for admitting material to be burned into the shaft, wherein the material inlet is in particular at the upper end of the respective shaft, such that the material falls into the respective shaft under gravity. The material inlet and/or the material outlet is/are in particular in the form of a lock for admitting and/or discharging material into the shaft kiln. A material inlet in the form of a lock is preferably designed such that only the raw material to be burned gets into the shaft, but not the ambient air. The material lock also prevents gas from escaping from the shaft via the material inlet. The lock is preferably designed to seal the shaft airtight against the environment and to allow solids, such as the material to be burned, to enter the shaft. The burning zone, preheating zone and cooling zone are preferably to be understood as meaning the regions of the shaft that are filled with material. Material-free spaces which are separated for example by a wall from the material-filled regions of the shaft are preferably not part of the preheating zone, burning zone or cooling zone.

The connecting duct is designed for gaseous connection of the two shafts and preferably connects the burning zones of the shafts to one another. In the course of operation of the PFR shaft kiln, one of the shafts at a time is operated as a burning shaft and is active, while the respective other shaft is operated as a regenerative shaft and is passive. The PFR shaft kiln is in particular operated in cycles, with switching of the function of the shafts after the cycle time has elapsed. This procedure is repeated continuously. In the active shaft operated as burning shaft, a fuel is introduced into the burning zone via the burner lances. The material to be burned is heated in the preheating zone of the burning shaft, preferably to a temperature of about 700 ° C. In the shaft operated as burning shaft, the burning zone is in the form of a concurrent burning zone, where the material to be burned flows parallel to the gas. The gas flows within the burning shaft from the preheating zone into the burning zone and then via the connecting duct into the burning zone and the preheating zone of the regenerative shaft. In the shaft operated as regenerative shaft, the gas flow in the preheating zone and the burning zone is in countercurrent to the material to be burned.

Both in the burning shaft and in the regenerative shaft, cooling gas is passed through the cooling zone in countercurrent to the material to be cooled and is preferably completely discharged from the shaft via the cooling gas outlet so that preferably only a small amount of cooling gas, if any, flows into the offgas outlet of the respective shaft. It is preferable when the cooling gas outlet is arranged within the preheating zone or the burning zone such that at least 60%, especially at least 70%, preferably at least 80% to at least 90%, of the cooling gas amount supplied to the PFR shaft kiln is discharged from the shaft via the cooling gas outlet. The cooling gas outlet is preferably arranged separately from the offgas outlet. The cooling gas outlet is especially arranged and configured within the preheating zone or the burning zone in such a way that 85% to 110%, especially 90% to 105%, preferably 100%, of the cooling gas amount supplied to the PFR shaft kiln is discharged via the cooling gas outlet as cooling gas exhaust air.

Each shaft preferably has at least one offgas outlet, for example at the upper end of the shaft within the preheating zone. The offgas outlet is preferably disposed above the material column in a material-free region of the preheating zone. The offgas is preferably discharged exclusively from one shaft, in particular the regenerative shaft. The discharged offgas is preferably sent to the respective other shaft, especially the burning shaft. Preferably, only a portion of the offgas discharged from the regenerative shaft is returned to at least one shaft. A portion of the offgas discharged from the regenerative shaft is, for example, discharged from the PFR shaft kiln and supplied, for example, to a further treatment, such as a sequestration. The offgas preferably consists of CO₂ and optionally H₂O. The PFR shaft kiln preferably has a combustion gas inlet for admitting combustion gas into the preheating zone or the burning zone, wherein the offgas outlet is optionally connected to the combustion gas inlet via an offgas recycle conduit.

A fuel is preferably supplied to the burning zone and/or the preheating zone of the shaft operated as a burning shaft via a fuel conduit. The fuel is preferably fed to burner lances disposed in the burning zone and/or the preheating zone. The fuel is for example a fuel gas, such as blast furnace gas or natural gas, or coal dust or biomass or liquid fuels. The material is preferably heated to a temperature of about 1050 ° C. in the burning zone.

Each shaft preferably has a multiplicity of burner lances which extend at least partly through the preheating zone and in particular open into the burning zone of the respective shaft and serve to conduct, for example, fuel and/or an oxidant gas, such as air or oxygen-enriched air or pure oxygen.

Recycling the offgas into at least one shaft makes it possible to produce lime with a high reactivity while simultaneously producing process gas having a CO₂content of more than 30 vol %, especially more than 50 vol %, preferably more than 70 vol %, based on dry gas. Such a process offgas enables liquefaction and sequestration thereof with a relatively low level of complexity. For example, the liquefied process offgas is supplied to further process steps or stored. The above-described PFR shaft kiln may alternatively also be used to produce offgas having a lower CO₂ content, for example 40% to 50% for soda production or 30% to 35% based on the dry gas for production of beet sugar or precipitated calcium carbonate.

The cooling gas outlet is preferably entirely arranged within the preheating zone or the burning zone so that the cooling gas is passed out of the preheating zone or the burning zone through the cooling gas outlet. The cooling gas outlet is especially fluidically connected to the preheating zone and/or the burning zone, wherein the cooling gas outlet is preferably arranged within the regenerative shaft downstream of the burning zone in the gas flow direction. Each shaft preferably has at least one cooling gas outlet, wherein preferably only the cooling gas outlet arranged in the shaft operated as the regenerative shaft is open and the cooling gas outlet of the burning shaft is fluidically closed.

The inventors have found that the oxygen-containing cooling gas flows within the shafts substantially separately to the combustion gas, thus resulting in only very slight mixing of the gas streams of the combustion gas and the cooling gas. Withdrawal of the cooling gas via the cooling gas outlet in the preheating zone or the burning zone has the advantage over removal of the cooling gas from the cooling zone that the heat of the cooling gas is additionally available to the PFR shaft kiln for heating the material in the burning zone and the preheating zone. In the PFR shaft kiln according to the invention the cooling air preferably flows through a large part, especially almost the entire amount, of the material bed. This results in an optimal thermal balance, with the result that no additional construction height of the PFR shaft kiln is required. It is further possible to dispense with a recuperator arranged downstream of the cooling gas outlet to utilize the waste heat.

In a first embodiment the cooling gas outlet is arranged in the outer wall of the shaft. It is preferable when the cooling gas outlet extends entirely through the outer wall of the shaft and is especially arranged in the outer wall surrounding the preheating zone or the burning zone. The PFR shaft kiln preferably has a refractory lining which extends for example from the cooling zone to the preheating zone, especially to a lower region of the preheating zone. The cooling gas outlet is preferably arranged above the refractory lining or at an upper end region of the refractory lining. The cooling gas outlet is preferably arranged entirely in the preheating zone or the burning zone with the result that the cooling air from the cooling zone especially flows entirely into the burning zone. A cooling gas outlet arranged in the outer wall of the preheating zone or the burning zone provides a constructionally very simple solution for cooling gas withdrawal. Existing lime kilns may be revamped at low cost.

In a further embodiment the PFR shaft kiln comprises one or more burner lances which are arranged such that they open into the burning zone, wherein the cooling gas outlet is arranged downstream of at least one of the openings of the burner lances in the gas flow direction of the regenerative shaft. The cooling gas outlet is preferably arranged downstream of all openings of the burner lances in the gas flow direction. The burner lances for example comprise covers which are arranged in the respective shaft upstream of the inlets of the burner lances in the flow direction of the material. Each burner lance preferably has a cover assigned to it. The covers are configured and arranged such that they respectively protect at least the upper region of the burner lances from contact, especially impact of the material on the burner lances. The cooling gas outlet is preferably arranged below the cover, especially downstream of the cover in the material flow direction. The burner lances, especially the covers of the burner lances, represent a flow obstacle for the cooling gas and combustion gas flowing in the direction of the preheating zone, thus effecting turbulence and mixing of the gas streams upon passing the burner lances. An arrangement of the cooling gas outlet upstream of the covers of the burner lances in the flow direction of the gas is therefore advantageous to ideally exclusively discharge the cooling gas stream through the cooling gas outlet.

In a further embodiment each shaft comprises a cooling gas outlet, wherein each cooling gas outlet has assigned to it a respective control element for adjusting the cooling gas amount to be discharged via the cooling gas outlet and wherein the control element assigned to the cooling gas outlet of the burning shaft is closed so that preferably no cooling gas is dischargeable via the cooling gas outlet of the burning shaft. The cooling gas outlet is preferably connected to a cooling gas withdrawal conduit arranged outside the shaft. The control element is preferably fluidically connected to the cooling gas outlet and especially arranged in the cooling gas withdrawal conduit. The control element is for example a flap or a valve which is steplessly movable between an open position and a closed position. The control element assigned to the cooling gas outlet of the regenerative shaft is preferably configured and adapted such that 85% to 110%, especially 90% to 105%, preferably 100%, of the cooling gas amount supplied to the PFR shaft kiln is discharged as cooling gas exhaust air via the cooling gas outlet of the regenerative shaft. The cooling gas withdrawal conduit is for example connected to the combustion gas inlet, especially to the offgas recycle conduit for conducting the offgas discharged from the offgas outlet, so that the cooling gas discharged from the cooling gas outlet is supplied to the combustion gas inlet, especially the burning zone of the burning shaft. It is advantageous when in such an interconnection no CO2-containing gas is discharged into the atmosphere via the cooling gas outlet but rather the entirety of the offgas is preferably sent for further processing or storage via the offgas outlet.

In a further embodiment the cooling gas outlet is arranged in a region of the outer wall of the preheating zone or of the burning zone which faces away from the connecting duct. The PFR shaft kiln preferably comprises a direct connecting duct for direct connection of the burning shaft to the regenerative shaft. The shafts each have for example an angular, triangular, square, rectangular, round, oval, polygonal, semicircular, part-circular or circular cross section. The connecting duct preferably forms a direct fluidic connection between the two shafts, wherein the cooling gas from the burning shaft together with the combustion gas from the burning shaft flows directly into the connecting duct and then into the regenerative shaft. The PFR shaft kiln preferably does not comprise an annular duct in addition to and at the same height as the connecting duct and the shafts are preferably directly fluidically connected to one another without one or more annular ducts. For example the burning zone and the preheating zone of the shafts have a cross section which is substantially constant over the shaft length. The outer wall of the shafts pointing radially outward from the connecting duct extends especially exclusively vertically over the entire shaft length, especially over the length of the burning zone and the cooling zone. The cooling zone preferably has a cross section that enlarges in the direction of the connecting duct and opens into the connecting duct. The shafts of the PFR shaft kiln are preferably completely filled with material so that especially in the burning zone and the cooling zone there is no material-free annular space at the height of the connecting duct. The inventors have found that in a PFR shaft kiln having a direct connecting duct the oxygen-containing cooling gas flows from the cooling zone to the region of the regenerative shaft opposite the connecting duct and upward along the inside of the outer wall of the regenerative shaft. The cooling gas preferably flows substantially separately to the combustion gas from the burning zone so that only very slight mixing of the gas streams occurs. A cooling gas outlet in the outer wall of the regenerative shaft facing away from the connecting duct allows withdrawal of a large amount, especially virtually the entire amount, of the cooling gas from the regenerative shaft with the result that the offgas discharged from the shaft by the offgas outlet contains only a very small proportion, if any, of cooling air.

In a further embodiment the cooling gas outlet in the outer wall of the shaft extends in the horizontal direction. The cooling gas outlet is preferably in the form of a horizontal slot. The cooling gas outlet especially extends over the entire width of the outer wall of the shaft opposite the connecting duct. The cooling gas outlet for example comprises a plurality of apertures in the shaft outer wall which, for example, are arranged next to one another in the horizontal direction and preferably at a single height.

In a further embodiment the PFR shaft kiln comprises a cooling gas withdrawal means which is connected to the cooling gas outlet for conduction of the cooling gas and extends from the vertical central axis of the shaft to the cooling gas outlet. The PFR shaft kiln preferably comprises an indirect connecting duct. In a PFR shaft kiln having an indirect connecting duct the connecting duct is connected to a material-free annular space which circumferentially extends around the lower end of the burning zone. Both shafts preferably have a material-free annular space at the height of the connecting duct, these being fluidically connected to the connecting duct. The cooling gas withdrawal means is preferably arranged entirely within the preheating zone or the burning zone of the shaft and fluidically connected to the cooling gas outlet. The cooling gas withdrawal means preferably extends radially through the preheating zone or the burning zone of the regenerative shaft. The inventors have found that in a PFR shaft kiln having an indirect connecting duct the cooling gas flows centrally, especially along the central longitudinal axis of the regenerative shaft through the burning zone and the preheating zone substantially separately to the combustion gases flowing as a radially outer annular space. An arrangement of a cooling gas withdrawal means connected to the cooling gas outlet which extends radially outward from the central longitudinal axis provides a simple way to withdraw the cooling gas flowing separately to the combustion gases in the preheating zone or the burning zone.

In a further embodiment the cooling gas withdrawal means comprises a withdrawal hood and a conduit fluidically connected thereto. The withdrawal hood is preferably arranged coaxially to the shaft within the preheating zone and preferably has a round, especially circular, cross section. The withdrawal hood is for example pot-shaped or funnel-shaped and preferably open at the bottom. The conduit preferably extends from the withdrawal hood to the cooling gas outlet, especially horizontally in the radial shaft direction. This allows withdrawal of the cooling gas separately to the combustion gas from the preheating zone or the burning zone.

In a further embodiment the PFR shaft kiln has a combustion gas inlet connected to a combustion gas source comprising a combustion gas having an oxygen content of more than 60 vol %, preferably more than 75 vol %, especially more than 80 vol % to more than 95 vol %, of oxygen.

In a further embodiment each shaft has a respective cooling gas inlet, wherein each inlet has assigned to it a control element for adjusting the amount of cooling gas supplied to the respective cooling gas inlet and wherein the control elements are adjusted such that a smaller amount of cooling air is supplied to the burning shaft than to the regenerative shaft. The control element is for example a steplessly adjustable valve or a flap. The control element is for example arranged upstream of the cooling gas inlet and especially arranged in a cooling gas conduit connected to the cooling air inlet. The control elements are preferably configured and adapted such that 20% to 30%, preferably 25%, of the total cooling gas amount supplied to the PFR shaft kiln is supplied to the burning shaft.

The invention also comprises a method of burning material, such as carbonate rock, in a parallel-flow regenerative shaft kiln, wherein the embodiments and advantages described in relation to the parallel-flow regenerative shaft kiln also apply in in method terms to the method. In a method of burning material, such as carbonate rocks, in a parallel-flow regenerative shaft kiln having two shafts which are operated alternately as a burning shaft and as a regenerative shaft and are connected to one another by means of a connecting duct the material flows through a material inlet into a preheating zone for preheating the material, a burning zone for burning the material and a cooling zone for cooling the material to a material outlet, wherein a cooling gas is admitted into the cooling zone, wherein offgas is discharged from one of the shafts via an offgas outlet and wherein the cooling gas is discharged from at least one of the shafts via a cooling gas outlet in the preheating zone or the burning zone. The cooling gas preferably flows from the cooling zone into the burning zone in the regenerative shaft and subsequently, together with the offgas from the burning zone, through the burning zone into the preheating zone and exits the shaft, especially the regenerative shaft, via the cooling gas outlet arranged in the preheating zone or the burning zone. The offgas discharged from the shaft via the offgas outlet is preferably supplied to the burning shaft. The offgas is for example introduced into the preheating zone of the shaft operated as a burning shaft.

In one embodiment the cooling gas is discharged from the shaft via a cooling gas outlet arranged in the outer wall of the shaft.

In a further embodiment the cooling gas is preferably discharged exclusively from the regenerative shaft.

In a further embodiment the amount of cooling gas discharged from the regenerative shaft via the cooling gas outlet is adjusted using a control element. It is preferable when 85% to 110%, especially 90% to 105%, preferably 100%, of the cooling gas amount supplied to the PFR shaft kiln is discharged via the cooling gas outlet as cooling gas exhaust air.

In a further embodiment the PFR shaft kiln is supplied with a combustion gas having an oxygen content of more than 60 vol %, preferably more than 75 vol %, especially more than 80 vol % to more than 95 vol %, of oxygen.

In a further embodiment the burning shaft is supplied with a smaller amount of cooling air than the regenerative shaft.

In a further embodiment it is preferable when exclusively the cooling gas flowing centrally through the preheating zone or the burning zone is discharged from the shaft.

In a further embodiment it is preferable when exclusively the cooling gas flowing along the outer wall of the preheating zone is discharged from the shaft.

Each shaft preferably has a gas inlet, in particular a combustion gas inlet, which is arranged in the upper region of the shaft in the preheating zone and serves for the admission of the gas required for combustion. The gas inlet is preferably arranged above the material column in a material-free space of the preheating zone.

It is preferable when the shaft operated as the burning shaft is supplied with an oxidant. The oxidant is for example pure oxygen or oxygen-rich gas having an oxygen content of more than 60 vol %, at least 70 to 95 vol %, preferably more than 80 vol % or more than 90%. The oxidant is preferably introduced into the preheating zone of the burning shaft together with the offgas. It is also conceivable for the shaft to have, in the preheating zone, a separate oxidant inlet for admitting the oxidant into the shaft separately from the offgas.

The connecting duct is optionally configured as an overflow duct, wherein the overflow duct comprises a first connecting duct and a second connecting duct which are in a fluidically parallel arrangement. The connecting ducts are preferably arranged separately from one another. The first connecting duct is for example arranged above the second connecting duct.

The first connecting duct is for example arranged and configured such that exclusively the offgas from the burning zone can flow into the first connecting duct. In a further embodiment the second connecting duct is arranged and configured such that exclusively the cooling gas from the cooling zone can flow into the second connecting duct. This ensures that the cooling gas from the burning shaft is introduced into the regenerative shaft independently of the combustion gases and that a mixing of the combustion gases with the cooling gases within the overflow duct is reliably prevented.

The first connecting duct is for example in the form of a direct connecting duct and the second connecting duct in the form of an indirect connecting duct. The PFR shaft kiln comprises for example an annular duct in the form of a material-free space which is preferably fluidically connected to the overflow duct, especially the first or the second connecting duct.

The above-described PFR shaft kiln and the method of operating the PFR shaft kiln makes it possible to achieve a CO₂ content in the offgas of at least 30 vol %, especially at least 50 vol %, preferably at least 70 vol %. This enables further processing of the offgas in other industrial processes or storage of the CO₂-containing offgas.

### DESCRIPTION OF THE DRAWINGS

The invention shall now be more particularly elucidated below on the basis of a plurality of exemplary embodiments and with reference to the accompanying figures.

FIG. 1 shows a schematic diagram of a PFR shaft kiln in a sectional view in one exemplary embodiment.

FIG. 2 shows a schematic diagram of a PFR shaft kiln in a sectional view according to a further exemplary embodiment.

FIG. 3a and b each show a schematic diagram of a PFR shaft kiln in a longitudinal sectional view and a transverse sectional view according to a further exemplary embodiment.

FIG. 4a and b each show a schematic diagram of the gas flow path of a PFR shaft kiln in a longitudinal sectional view according to a further exemplary embodiment.

FIG. 5 shows a schematic diagram of a PFR shaft kiln in a sectional view according to a further exemplary embodiment.

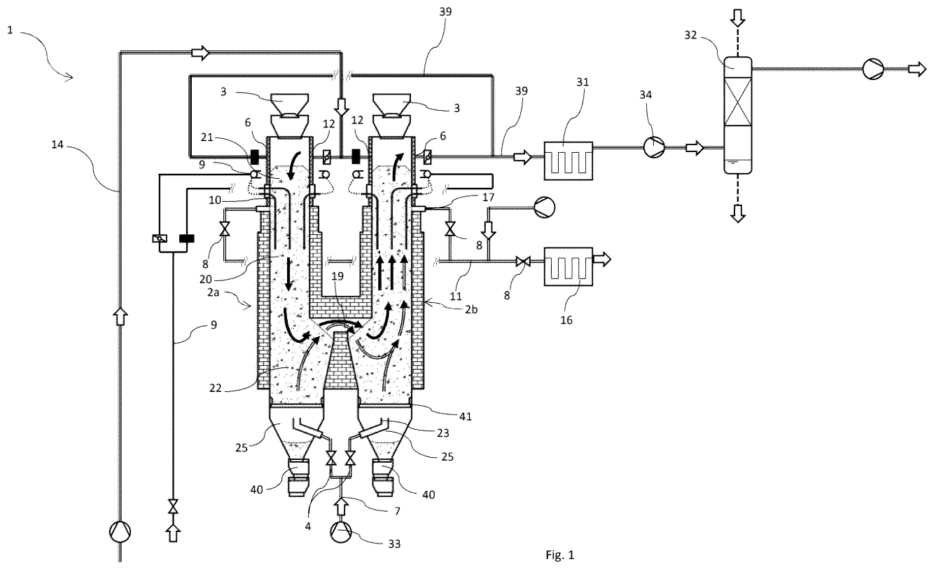

FIG. 1 shows a PFR shaft kiln 1 having two parallel and vertically oriented shafts 2. The shafts 2 of the PFR shaft kiln 1 are of substantially identical construction, and so only one of the two shafts 2 is fully provided with reference numerals in FIG. 1 and, for the sake of simplicity, only one of the two shafts 2 is described below. Each shaft 2 has a respective material inlet 3 for admitting material to be burned into the respective shaft 2 of the PFR shaft kiln 1. The material to be burned is in particular limestone and/or dolomite rock, preferably having a particle size of 10 to 200 mm, preferably of 15 to 120 mm, most preferably 30 to 100 mm. By way of example, the material inlets 3 are disposed at the upper end of the respective shaft 2, such that the material falls through the material inlet 3 into the shaft 2 under gravity. The material inlet 3 takes the form, for example, of an upper opening in the shaft 2 and in particular that of a lock 3, and preferably extends over the entirety or a portion of the cross section of the shaft 2. A material inlet in the form of a lock 3 is preferably configured such that only the raw material to be burned gets into the shaft 2, but not the ambient air. The lock 3 is preferably configured such that it seals off the shaft 2 against the environment in an airtight manner and allows solids, such as the material to be burned, to enter the shaft.

Each shaft 2 additionally has, at its upper end, a combustion gas inlet 12 for admitting combustion gas for combustion of fuels. The combustion gas is, for example, dedusted offgas from at least one of the shafts 2, wherein the offgas is optionally enriched with oxygen. Furthermore, each shaft 2 has an offgas outlet 6 for discharging offgases from the respective shaft 2. A respective control element is assigned to each offgas outlet 6 and combustion gas inlet 12 for example. Control elements, such as an adjustable-volume compressor, can preferably be used to adjust the amount of combustion gas in the respective combustion gas inlet 12 and the amount of offgas to be removed via the respective offgas outlet 6. The combustion gas inlet 12 and the offgas outlet 6 are arranged for example at the same height level and especially inside the preheating zone 21 of the respective shaft 2.

Arranged at the lower end of the shaft 2 is a material outlet 40 for discharging the burnt material. The material outlet 40 is, for example, a lock as described with reference to the material inlet 3.

The burned material is passed, for example, into an outlet funnel 25, to which the material outlet 40 of the shaft 2 connects. By way of example, the outlet funnel 25 is funnel-shaped. The outlet funnel 25 preferably has a cooling gas inlet 23 for admitting cooling gas into the respective shaft 2. The cooling gas is preferably passed into the cooling gas inlet 23 by means of a compressor 33.

In operation of the PFR shaft kiln 1, the material to be burned flows from top to bottom through the respective shaft 2, while the cooling air flows from bottom to top, in countercurrent to the material, through the respective shaft 2. The kiln offgas is discharged from the shaft 2 through the offgas outlet 6.

Following below the material inlet 3 and the combustion gas inlet 12 in the flow direction of the material is the preheating zone 21 of the respective shaft 2. The material and the combustion gas are preferably preheated to about 700 ° C. in the preheating zone 21. The respective shaft 2 is preferably filled with material to be burned. The material is preferably supplied to the respective shaft 2 above the preheating zone 21. At least a portion of the preheating zone 21 and the portion of the respective shaft 2 which follows it in the flow direction of the material are surrounded, for example, by a refractory lining.

A multiplicity of burner lances 10 are optionally arranged in the preheating zone 21 and each serve as an inlet for fuel, such as fuel gas, oil or ground solid fuel. The PFR shaft kiln 1 has, for example, a cooling device for cooling the burner lances 10. The cooling device comprises, for example, a plurality of annular cooling air conduits which extend annularly around the shaft region in which the burner lances 10 are disposed. Cooling air for cooling of the burner lances 10 preferably flows through the annular cooling air conduits. The burner lances 10 are for example cooled by means of the offgas discharged via the offgas outlet 6. The offgas outlet 6 is preferably connected to the burner lances 10 for conduction of offgas to the burner lances 10.

A plurality, for example twelve or more, of burner lances 10 are preferably arranged in each shaft 2 at a substantially uniform distance from one another. By way of example, the burner lances 10 have an L shape and preferably extend in a horizontal direction into the respective shaft 2 and in a vertical direction, in particular in the flow direction of the material, inside the shaft 2. The ends of the burner lances 10 of a shaft 2 are preferably all arranged at the same height level. Preferably, the plane on which the lance ends are arranged is in each case the lower end of the respective preheating zone 21. The burner lances 10 are preferably connected to a fuel conduit 9 for conduction of fuel to the burner lances 10. By way of example, the fuel conduit 9 is at least partly in the form of an annular conduit that extends circumferentially around the respective shaft 2. Preferably, each shaft 2 has a fuel conduit which is assigned in each case to the burner lances 10 of the shaft 2 and which in particular has a respective control element for adjusting the amount of fuel to the burner lances 10.

The preheating zone 21 is followed in the flow direction of the material by the burning zone 20. The burner lances 10 open into the burning zone 20 for example. The flame of the burner lances 10 preferably extends into the burning zone 20. In the burning zone 20, the fuel is combusted and the preheated material is burned at a temperature of about 1000 ° C. The PFR shaft kiln 1 also has a connecting duct 19 for gaseous connection of the two shafts 2 to one another. There is in particular no material to be burned in the connecting duct 19.

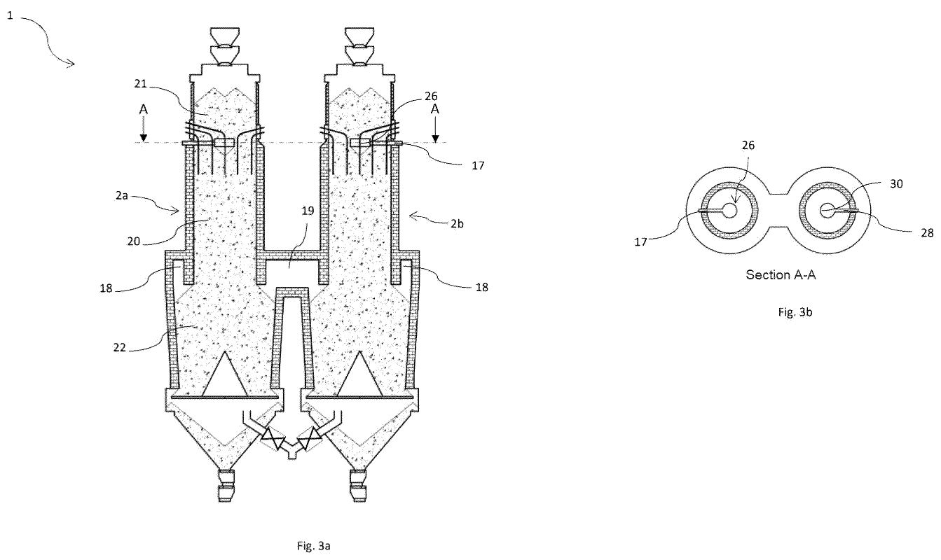

FIG. 1 shows for example a PFR shaft kiln 1 having a direct connecting duct 19 which has an angular shaft cross section for example. The shafts 2 of the PFR shaft kiln 1 have for example an angular, triangular, square, rectangular, round, oval, polygonal, semicircular, part-circular or circular cross section. The connecting duct 19 forms a direct fluidic connection between the two shafts 2, wherein the cooling gas from the burning shaft 2a together with the combustion gas from the burning shaft 2a flows directly into the connecting duct 19 and then into the regenerative shaft 2b. The PFR shaft kiln 1 of FIG. 1 preferably has no annular duct 18 as described with reference to FIG. 3a and b. For example the burning zone 20 and the preheating zone 21 of the shafts 2 have a cross section which is substantially constant over the shaft length. The outer wall of the shafts 2 pointing radially outward from the connecting duct extends especially exclusively vertically over the entire shaft length, especially over the length of the burning zone 20 and the cooling zone 22. The cooling zone 22 preferably has a cross section that widens in the direction of the connecting duct 19 and opens into the connecting duct 19. The shafts 2 of the PFR shaft kiln 1 of FIG. 1 are preferably completely filled with material so that especially in the burning zone 20 and the cooling zone 22 there is no material-free space.

The burning zone 20 is followed in the flow direction of the material in each shaft 2 by the cooling zone 22 which extends as far as the material outlet 40. The cooling zone 22 is for example formed in a shaft section having a substantially constant or downwardly narrowing cross section. The material is cooled within the cooling zone 22 to about 100 ° C. in countercurrent to the cooling gas flowing through the material. The cooling gas flowing into the cooling zone 22 via the cooling gas inlet 23 preferably flows entirely into the burning zone 20 and preferably the preheating zone 21 of the respective shaft 2.

A discharge device 41 is preferably disposed at the material outlet end of each shaft 2. The discharge devices 41 include, for example, horizontal plates, preferably a discharge table, which allow the material to pass through laterally between the discharge table and the housing wall of the PFR shaft kiln. The discharge device 41 is preferably designed as a slide table or turntable or as a table with pushable scrapers. This enables a uniform throughput rate of the material to be burned through the shafts 2. By way of example, the discharge device 41 further comprises the outlet funnel 25, which follows the discharge table and has the material outlet 40 mounted at its lower end.

In operation of the PFR shaft kiln 1, one of the shafts 2 is active at any time, with the respectively other shaft 2 being passive. The active shaft 2a is referred to as the burning shaft and the passive shaft 2 as the regenerative shaft 2b. The PFR shaft kiln 1 is in particular operated cyclically, with a typical number of cycles being 75 to 150 cycles per day, for example. After the cycle time has elapsed, the function of the shafts 2 is switched. This procedure is repeated continuously. Material such as limestone or dolomite rock is alternately supplied to the shafts 2 via the material inlets 3. In the active shaft 2 operated as the burning shaft 2a, a fuel is introduced into the burning shaft 2 via the burner lances 10. The material to be burned is heated in the preheating zone 21 of the burning shaft 2 a, preferably to a temperature of about 700 ° C. In the exemplary embodiment of FIG. 1, the left-hand shaft 2 is operated as the burning shaft 2a, while the right-hand shaft 2 is operated as the regenerative shaft 2b.

In operation of the PFR shaft kiln 1, both in the burning shaft 2a and in the regenerative shaft 2b, the cooling gas flows through the cooling zone 22 in countercurrent to the material to be cooled and is preferably passed entirely into the burning zone 20.

Inside the shaft 2 operated as the burning shaft 2a the combustion gas flows through the combustion gas inlet 12 into the burning shaft and in concurrent with the material in the burning zone 20 into the connecting duct 19 and then into the shaft 2 operated as a regenerative shaft 2b. Inside the regenerative shaft 2b the gas flows from the connecting duct 19 in countercurrent to the material to be burned through the burning zone 20 into the preheating zone 21 and exits the regenerative shaft 2b through the offgas outlet 6 of the regenerative shaft 2b. The offgas discharged from the shaft 2 is preferably at a temperature of 60 ° C. to 160 ° C., preferably 100 ° C. The offgas is passed into an offgas conduit 39 connected to the offgas outlet 6. The offgas conduit 39 optionally has, downstream of the offgas outlet 6 in flow direction of the offgas, an offgas filter 31 for filtering fine particles, in particular dust, out of the offgas. The PFR shaft kiln 1 preferably comprises a plurality of control elements, wherein especially a respective control element is assigned to a respective offgas outlet 6 or combustion gas inlet 12 to control the flow to or from the offgas outlet 6 and the combustion gas inlet 12. The control element is, for example a throttle flap or a compressor. The combustion gas inlet 12 is preferably connected to an oxidant conduit 14, so that an oxidant, preferably air or pure oxygen, is introduced into the combustion gas inlet 12. It is likewise conceivable that the oxidant is an oxygen-rich gas having an oxygen content of at least 30 vol %, especially at least 50 vol % or 60 vol %, preferably 70 vol % to 95 vol %, preferably 90 vol %. The combustion gas inlet 12 is preferably connected to an upstream control element so that the oxidant is preferably supplied merely to the combustion gas inlet 12 of the shaft 2 operated as a burning shaft 2a.

The offgas conduit 39 comprises a compressor 34 and a cooling device 32 downstream of the offgas filter 31 for example. The offgas is preferably discharged downstream of the cooling device 32. Preferably, the entire amount of CO2 from the calcination and the combustion, and the water from the combustion, are discharged from the PFR shaft kiln 1. The cooling device 32 is, for example, a heat exchanger which is preferably operated in countercurrent with a coolant, such as water.

The oxidant conduit 14 preferably comprises a control element, for example a valve or a flap, which may be used to adjust the amount of oxidant entering the combustion gas inlet 12.

The offgas from the PFR shaft kiln of FIG. 1 Preferably Has a CO₂ content of 30 vol %-40 Vol %, especially 35 vol %.

The PFR shaft kiln 1 preferably has a cooling gas outlet 17 for discharging cooling gas from the shaft 2, especially from the regenerative shaft 2b. The cooling gas outlet 17 is arranged, for example, in the preheating zone 21 of the PFR shaft kiln 1, especially of the regenerative shaft 2b. Each shaft 2 preferably has a cooling gas outlet 17. The cooling gas outlet 17 is in particular arranged in the outer wall of the shaft 2, preferably in the outer wall of the preheating zone 21 or of the burning zone 20, and extends fully therethrough and out of the respective shaft 2. The cooling gas outlet 17 is preferably entirely arranged within the preheating zone 21, so that the cooling gas is passed out of the preheating zone 21 and the shaft 2 via the cooling gas outlet 17. The cooling gas outlet 17 is preferably fluidically connected to the preheating zone 21 so that the cooling gas may preferably be passed through the cooling zone 22 and the burning zone 20 into the preheating zone 21 and then through the cooling gas outlet 17. The cooling gas outlet 17 is preferably arranged in a region of the outer wall of the preheating zone 21 that faces away from the connecting duct 19. The cooling gas outlet 17 is preferably arranged in the outer wall of the shaft 2, especially of the regenerative shaft 2b, opposite the connecting duct 19.

In operation of the PFR shaft kiln 1 the cooling gas preferably flows from the cooling zone 22 into the burning zone 20 and subsequently, together with the offgas from the burning zone 20, through the burning zone 20 into the preheating zone 21 and exits the shaft 2, especially the regenerative shaft 2b, via the cooling gas outlet 17 arranged in the preheating zone 21. FIG. 1 additionally shows the gas flow within the PFR kiln 1, wherein the CO₂-containing combustion gas is represented by the arrows shaded black and the oxygen-containing cooling gas is represented by the arrows shaded white. The inventors have found that in the regenerative shaft 2b the oxygen-containing cooling gas flows along the outer wall of the regenerative shaft 2b opposite the connecting duct 19 into the burning zone 20 and the preheating zone 21. The oxygen-containing cooling gas preferably flows within the shafts 2 substantially separately to the combustion gas, thus resulting in only very slight mixing of the gas streams of the combustion gas and the cooling gas. Withdrawal of the cooling gas via the cooling gas outlet in the preheating zone or the burning zone has the advantage over removal of the cooling gas from the cooling zone that the heat of the cooling gas is additionally available to the PFR shaft kiln 1 for heating the material in the burning zone 20 and the preheating zone 21. In the PFR shaft kiln 1 according to the invention the cooling air preferably flows through a large part, especially almost the entirety, of the material bed and has a relatively low outlet temperature. This results in an optimal thermal balance, with the result that no additional construction height of the PFR shaft kiln 1 is required. It is further possible to dispense with a recuperator arranged downstream of the cooling gas outlet to utilize the waste heat.

The cooling gas outlet 17 is preferably arranged downstream of the ends, especially fuel outlets, of the burner lances 10 in the gas flow direction of the regenerative shaft 2b. The cooling gas outlet 17 is preferably arranged downstream of the offgas outlet 6 in the material flow direction. The cooling gas outlet 17 is for example slot-shaped. The cooling gas outlet 17 especially extends horizontally preferably over the entire width of the shaft outer wall. It is likewise conceivable for the cooling gas outlet 17 to have a plurality of openings extending through the outer wall of the shaft 2, especially of the preheating zone 21, which are for example arranged next to one another in the horizontal direction over the total width of the outer wall of the shaft 2 and are preferably uniformly spaced apart from one another.

The burner lances 10 for example comprise covers (not shown in FIG. 1) which are arranged in the respective shaft 2 upstream of the inlets of the burner lances 10 in the flow direction of the material. The covers are configured and arranged such that they respectively protect at least the upper region of the burner lances 10 from contact, especially impact of the material on the burner lances 10. The cooling gas outlet 17 is preferably arranged below the cover, especially downstream of the cover in the material flow direction.

The shaft 2 preferably has a lining, which especially comprises a refractory lining. The cooling gas outlet 17 is preferably arranged at the upper end region of the refractory lining.

The PFR shaft kiln 1 preferably has a cooling gas withdrawal conduit 11 which is connected to the cooling gas outlet 17 for conducting the cooling air out of the shaft 2. The cooling gas withdrawal conduit 11 is arranged outside the shaft and connected to a filter 16. The filter 16 is preferably a particle filter, especially a dust filter. The cooling air withdrawn via the cooling air outlet 17 preferably has a temperature of 200 ° C. to 400 ° C. The cooling air withdrawal conduit 11 of the PFR shaft kiln 1 for example comprises a control element 8, for example a flap or a valve, for adjusting the amount of cooling air withdrawn via the cooling gas outlet from the preheating zone 21 or the burning zone 20. The cooling gas withdrawal conduit 11 is by way of example supplied with air via a compressor or fan. The cooling gas withdrawal conduit 11 comprises for example at least two control elements, wherein each control element 8 is assigned to a respective cooling gas outlet 17 for adjustment of the respective cooling gas amount. It is preferable when only the control element 8 assigned to the shaft 2 operated as a regenerative shaft 2b is open while the control element 8 assigned to the burning shaft 2a is closed. The cooling gas is preferably discharged from the PFR shaft kiln 1 downstream of the filter 16. It is likewise conceivable that the cooling gas withdrawal conduit 11 is connected to the oxidant conduit 14, especially the combustion gas inlet 12, with the result that the withdrawn cooling air is supplied to the burning shaft 2a as combustion gas. It is advantageous when in such an interconnection no CO₂ is discharged into the atmosphere via the cooling gas outlet 17 but rather the entirety of the offgas is discharged via the offgas outlet and then preferably sent for further processing or storage.

It is preferable when each shaft 2 has a cooling gas inlet 23 arranged in the cooling zone 22 which is especially connected to a cooling gas feed conduit 7. Each cooling gas inlet 23 has assigned to it for example a respective control element 4, such as a flap or a valve, which is connected to the cooling gas feed conduit 7 for adjusting the amount of cooling gas supplied to the respective cooling gas inlet 23. It is preferable when the control elements 4 are adjusted such that the burning shaft 2a is supplied with a smaller amount of cooling air than the regenerative shaft 2b. The burning shaft 2a is preferably supplied with for instance 20% to 30%, preferably 25%, of the total cooling gas amount supplied to the PFR shaft kiln 1.

The PFR shaft kiln 1 of FIG. 1 preferably has an offgas having a CO₂content of more than 30vol %.

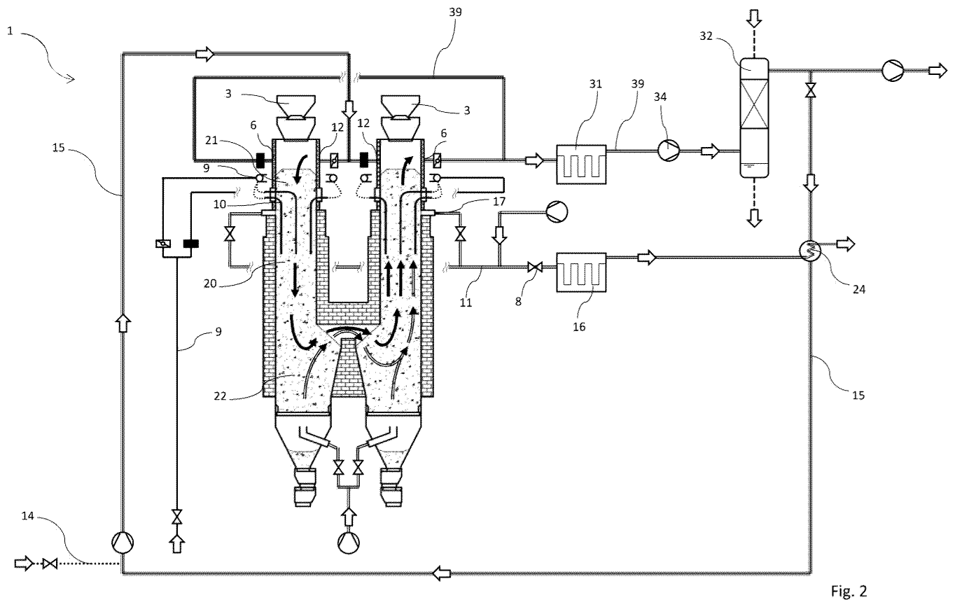

FIG. 2 shows a further exemplary embodiment of a PFR shaft kiln, said kiln largely corresponding to the PFR shaft kiln of FIG. 1. Identical elements are provided with identical reference signs. In the PFR shaft kiln 1 of FIG. 2 the left-hand shaft 2 is likewise operated as the burning shaft 2a for example. In contrast to the PFR shaft kiln of FIG. 1 the PFR shaft kiln 1 of FIG. 2 has an offgas recycle conduit 15 which branches off from the offgas conduit 39 and supplies a portion of the offgas to the combustion gas inlet 12 of the shaft 2, especially of the burning shaft 2a. The offgas recycle conduit 15 is preferably connected to the combustion gas inlet 12 and especially branches off from the offgas conduit 39 downstream of the cooling device 32. Offgas not supplied to the combustion gas inlet 12 via the offgas recycle conduit 15 is preferably discharged from the PFR shaft kiln 1. The offgas recycle conduit 15 is for example connected to an oxidant conduit 14 for passing an oxidant into the offgas recycle conduit 15. The oxidant is, preferably, air or pure oxygen. The oxidant is for example an oxygen-rich gas having an oxygen content of at least 30 vol %, especially at least 50 vol % or 60 vol %, preferably 70 vol % to 95 vol %, preferably 90 vol %. The oxidant conduit 14 is preferably connected to an oxidant source and preferably comprises a control element for adjusting the amount of oxidant entering the offgas recycle conduit 15.

The PFR shaft kiln 1 of FIG. 2 for example comprises a heat exchanger 24 connected to the offgas recycle conduit 15 and the cooling air withdrawal conduit 11. Optionally no heat exchanger 24 and preferably also no fan is provided for supplying air to the cooling gas withdrawal conduit 11. The PFR shaft kiln 1 of FIG. 1 preferably has an offgas having a CO₂ content of more than 70 vol %, especially more than 75 vol %, wherein an offgas having a CO₂ content of about 50 vol % is preferably achievable when the above-described heat exchanger 24 and preferably also the fan in the cooling gas withdrawal conduit 11 are eschewed. Such a process offgas can be liquefied and sequestered with a relatively low degree of complexity. For example, the liquefied process offgas is supplied to further process steps or stored. The above-described PFR shaft kiln may alternatively also be used to produce offgas having a lower CO₂ content, for example 45% for soda production or 30% for production of beet sugar or precipitated calcium carbonate.

FIG. 3a and b show a further exemplary embodiment of a PFR shaft kiln 1, wherein said kiln largely corresponds to the PFR shaft kiln of FIGS. 1 and 2. Identical elements are provided with identical reference signs. FIG. B shows a sectional view of the PFR shaft kiln at the A-A section illustrated in FIG. 3a. The cooling gas withdrawal conduit 11, the offgas recycle conduit 15, the fuel conduit 9 and the oxygen conduit 14 are not shown for the sake of simplicity. In contrast to the PFR shaft kiln of FIGS. 1 and 2, the PFR shaft kiln 1 of FIG. 3 has an indirect connecting duct 19. The burning zone 20 extends for example in a shaft section having a substantially constant cross section. The lower region of the shaft section extends for example into the upper region of the cooling zone 22, with the result that an annular duct 18 is formed between the burning zone 20 and the cooling zone 22. The annular duct 18 forms a material-free space in which no material to be burned is arranged. The annular duct 18 preferably extends circumferentially around the lower region of the burning zone 20. The shafts 2 of FIG. 3a each have an annular duct 18 for example, the latter being connected to the connecting duct 19. The annular duct 18 is preferably arranged at the height of the connecting duct 19 so that the connecting duct 19 is in the form of an indirect connecting duct. An indirect connecting duct 19 is to be understood as meaning a connecting duct which is fluidically connected to an annular duct 18 so that the cooling gas together with the combustion gas from the burning shaft 2a flows through the annular duct 18 of the burning shaft 2a into the connecting duct 19 and then through the annular duct 18 of the regenerative shaft 2b into the regenerative shaft 2b. The cross section of the shaft section of the cooling zone 22 is for example larger than the cross section of the lower region of the burning zone 20, so that a further material-free space 18, especially an annular terrace, in which no material is arranged is formed at the upper end of the cooling zone 22 and adjacent to the burning zone 20. Arranged at the lower end of the cooling zone 22 is a preferably conical flow device which serves to conduct the material in the direction of the shaft wall.

The PFR shaft kiln 1 of FIG. 3 a and b comprises for example a cooling gas withdrawal means 26 for passing the cooling gas to the cooling gas outlet 17. The cooling gas withdrawal means 26 is preferably arranged at least partially or entirely within the preheating zone 21. The cooling gas withdrawal means 26 especially extends from the vertical central axis of the shaft 2, especially the preheating zone 21, radially outwards to the cooling gas outlet 17 and is preferably fluidically connected thereto. The cooling gas withdrawal means 26 preferably comprises a conduit 28, especially a pipe conduit 28, that is connected to the cooling gas outlet 17 and at least partially or completely extends through the preheating zone 21 of the shaft 2, especially of the regenerative shaft 2b. The cooling gas withdrawal means 26 preferably also comprises a withdrawal hood 30 which is preferably arranged coaxially with the shaft 2 within the preheating zone 21. The withdrawal hood 30 preferably has a round, especially circular, cross section and is for example pot-shaped or funnel-shaped and preferably open at the bottom.

The shafts 2 of the PFR shaft kiln 1 of FIG. 3a and b preferably have a round, especially circular, cross section. The shafts may also have a circular, semicircular or part-circular cross section.

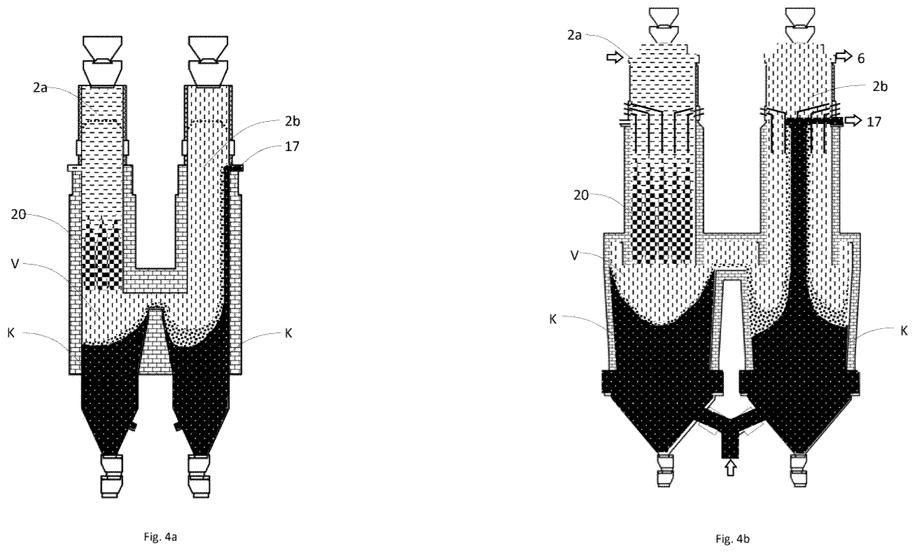

FIG. 4a shows the PFR shaft kiln of FIGS. 1 and 2 and FIG. 4b shows the PFR shaft kiln 1 of FIG. 3a and b, wherein the gas flows of the cooling air K and the combustion gases V are shown. The PFR shaft kiln 1 of FIG. 4a comprises the direct connecting duct 19 and so the cooling air in the regenerative shaft 2b flows through the regenerative shaft 2b along the lateral outer wall opposite the connecting duct 19.

The PFR shaft kiln 1 of FIG. 4b comprises the indirect connecting duct 19 and so the cooling air in the regenerative shaft 2b flows through the regenerative shaft 2b along the vertical central axis of the shaft 2. FIG. 4a and b also show regions where mixing of the combustion gas with the cooling gas occurs. These ranges are preferably very small and so the offgas has a very low oxygen content of at most about 10 vol %.

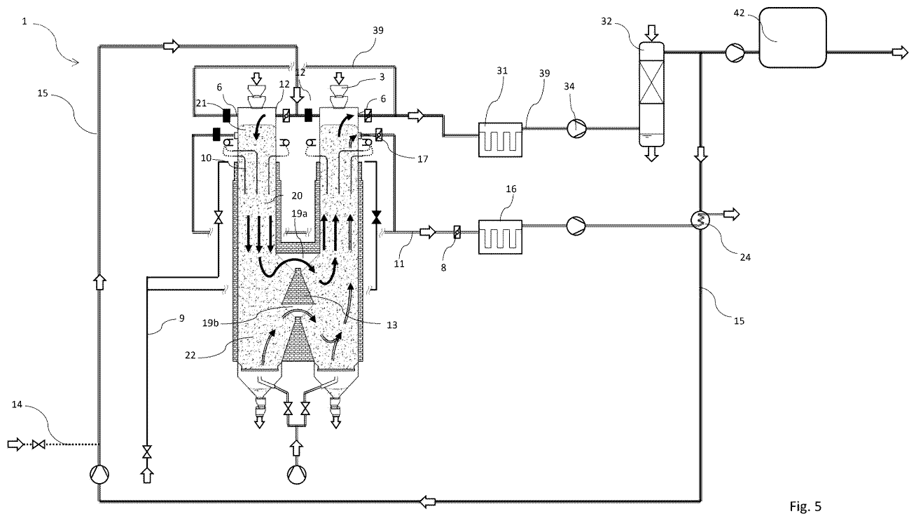

FIG. 5 shows a further exemplary embodiment of a PFR shaft kiln 1 which substantially corresponds to that of FIG. 2, wherein identical elements are provided with identical reference numerals. In contrast to the PFR shaft kiln of FIG. 2 the PFR shaft kiln 1 of FIG. 5 has an overflow duct 19 which comprises two connecting ducts 19a and 19b. The connecting ducts 19a and 19b are arranged for example in parallel and separately from one another. For example the connecting ducts 19a and 19b are fluidically separated from one another by an especially horizontal separating element 13, for example a dividing wall. The shaft kiln 1 comprises for example a first connecting duct 19a which is especially directly connected to the burning zone 20 and preferably arranged above a second connecting duct 19b. The first connecting duct 19a is for example arranged and configured such that only the offgas from the burning zone 20 is introducible thereto. The first connecting duct 19a and the second connecting duct 19b are optionally each configured as a material-free space containing no material to be burned. The second connecting duct 19b is preferably arranged below the first connecting duct 19a and is especially in direct fluid connection with the cooling zone 22. The second connecting duct 19b is for example arranged and configured such that only the cooling gas from the cooling zone 22 is introducible into the second connecting duct 19b.

The overflow duct 19 for example forms a fluidic connection between the two shafts 2, wherein the cooling gas from the burning shaft 2a, especially separately from the combustion gas from the burning shaft 2a, flows into the overflow duct 19 and then into the regenerative shaft 2b. It is preferable when the first connecting duct 19a is in the form of a direct connecting duct 19a, wherein the second connecting duct 19b is for example likewise in the form of a direct connecting duct 19b.

The PFR shaft kiln 1 of FIG. 5 for example further comprises a buffer tank 45 which is preferably supplied with the offgas not recirculated via the offgas recycle conduit 15. The buffer tank 45 is configured such that it intermediately stores a certain amount of offgas before this is withdrawn from the buffer tank 45 for further processing for example. At least one fan is arranged upstream of the buffer tank and downstream of the buffer tank respectively in the flow direction of the offgas for example.

### LIST OF REFERENCE NUMERALS

1 PFR shaft kiln
2 shaft
2a burning shaft
2b regenerative shaft
3 material inlet/lock
4 control element
6 offgas outlet
7 cooling gas feed conduit
8 control element
9 fuel conduit
10 burner lances
11 cooling gas withdrawal conduit
12 combustion gas inlet
13 separating element
14 oxidant conduit
15 offgas recycle conduit
16 filter
17 cooling gas outlet
18 annular duct/material-free space
19 connecting duct/overflow duct
19a, b connecting ducts
20 burning zone
21 preheating zone
22 cooling zone
23 cooling gas inlet
24 heat exchanger
25 outlet funnel
26 cooling gas withdrawal means
28 conduit
30 withdrawal hood
31 offgas filter
32 cooling device
33, 34 compressor
39 offgas conduit
40 material outlet/lock
42 buffer tank
K cooling air
V combustion air

1-18. (canceled)

19. A parallel-flow regenerative shaft kiln for burning and cooling material, such as carbonate rock, comprising:
two shafts which are operable alternately as a burning shaft and as a regenerative shaft and are connected to one another by a connecting duct;
wherein in the flow direction of the material each shaft comprises a preheating zone for preheating the material, a burning zone for burning the material and a cooling zone for cooling the material;
wherein each shaft comprises an offgas outlet for discharging offgas from the shaft;
wherein the PFR shaft kiln has a cooling gas outlet for discharging cooling gas from the shaft and wherein the cooling gas outlet is arranged in the preheating zone or the burning zone.

20. The parallel-flow regenerative shaft kiln as claimed in claim 19, wherein the cooling gas outlet is arranged in the outer wall of the shaft.

21. The parallel-flow regenerative shaft kiln as claimed in claim 19, wherein one or more burner lances are arranged such that they open into the burning zone and wherein the cooling gas outlet is arranged downstream of at least one of the openings of the burner lances in the gas flow direction of the regenerative shaft.

22. The parallel-flow regenerative shaft kiln as claimed in claim 19, wherein each shaft comprises a cooling gas outlet and wherein each cooling gas outlet has assigned to it a respective control element for adjusting the cooling gas amount to be discharged via the cooling gas outlet and wherein the control element assigned to the cooling gas outlet of the burning shaft is closed.

23. The parallel-flow regenerative shaft kiln as claimed in claim 19, wherein the cooling gas outlet is arranged in a region of the outer wall of the preheating zone or of the burning zone which faces away from the connecting duct.

24. The parallel-flow regenerative shaft kiln as claimed in claim 23, wherein the cooling gas outlet extends in the horizontal direction in the outer wall of the shaft.

25. The parallel-flow regenerative shaft kiln as claimed in claim 19, wherein the PFR shaft kiln comprises a cooling gas withdrawal means which is connected to the cooling gas outlet for conduction of the cooling gas and extends from the central axis of the shaft to the cooling gas outlet.

26. The parallel-flow regenerative shaft kiln as claimed in claim 25, wherein the cooling gas withdrawal means comprises a withdrawal hood and a conduit fluidically connected thereto.

27. The parallel-flow regenerative shaft kiln as claimed in claim 19, wherein each shaft has a respective cooling gas inlet, wherein each inlet has assigned to it a control element for adjusting the amount of cooling gas supplied to the respective cooling gas inlet and wherein the control elements are adjusted such that a smaller amount of cooling air is supplied to the burning shaft than to the regenerative shaft.

28. A method of burning material, such as carbonate rock, in a parallel-flow regenerative shaft kiln having two shafts which are operated alternately as a burning shaft and as a regenerative shaft and are connected to one another by a connecting duct, comprising:
causing the material to flow through a material inlet into a preheating zone for preheating the material, a burning zone for burning the material and a cooling zone for cooling the material to a material outlet;
wherein a cooling gas is admitted into the cooling zone;
wherein offgas is discharged from one of the shafts via an offgas outlet;
wherein the cooling gas is discharged from at least one of the shafts via a cooling gas outlet in the preheating zone or the burning zone.

29. The method as claimed in claim 28, wherein the cooling gas is discharged from the shaft via a cooling gas outlet arranged in the outer wall of the shaft.

30. The method as claimed in claim 28, wherein the cooling gas is discharged from the regenerative shaft.

31. The method as claimed in claim 28, wherein the amount of cooling gas discharged from the regenerative shaft via the cooling gas outlet is adjustable by a control element.

32. The method as claimed in claim 28, wherein the PFR shaft kiln is supplied with a combustion gas having an oxygen content of more than 60 vol %.

33. The method as claimed in claim 28, wherein the PFR shaft kiln is supplied with a combustion gas having an oxygen content of more than 75 vol %.

34. The method as claimed in claim 28, wherein the PFR shaft kiln is supplied with a combustion gas having an oxygen content of more than 80 vol %.

35. The method as claimed in claim 28, wherein the PFR shaft kiln is supplied with a combustion gas having an oxygen content of more than 95 vol %.

36. The method as claimed in claim 28, wherein the burning shaft is supplied with a smaller amount of cooling air than the regenerative shaft.

37. The method as claimed in claim 28, wherein the cooling gas flowing centrally through the preheating zone is discharged.

38. The method as claimed in claim 28, wherein the cooling gas flowing along the outer wall of the preheating zone is discharged.
